(19) United States
(12) Patent Application Publication
(10) Pub. No.: US 2007/0114388 A1
(43) Pub. Date: May 24, 2007

(54) Imaging mass spectrometer

(75) Inventors: Kiyoshi Ogawa, Kyoto-shi (JP); Sadao Takeuchi, Kyoto-shi (JP); Takahiro Harada, Kyoto-shi (JP); Yoshihiro Ueno, Kyoto-shi (JP); Fujio Inoue, Kyoto-shi (JP); Mitsutoshi Setou, Kyoto-shi (JP)

Correspondence Address: KANESAKA BERNER AND PARTNERS LLP, 1700 DIAGONAL RD, SUITE 310, ALEXANDRIA, VA, 22314-2848, US

(73) Assignee: SHIMADZU CORPORATION, Kyoto (JP)

(21) Appl. No.: 11/590,802

(22) Filed: Nov. 1, 2006

(30) Foreign Application Priority Data
Nov. 2, 2005 (JP) 2005-319495

(51) Int. Cl. H01J 49/00

(52) U.S. Cl. 250/288

(57) ABSTRACT

An imaging mass spectrometer, an image of a sample is generated, and a region in the image is selected in accordance with predetermined criteria. Then, a mass analysis of the region is performed while scanning the sample in the selected region with a laser beam spot. By computing the total or average of the results in the region, a high precision analytical value in the region can be obtained. In a biological sample, by preliminarily performing a staining process on the biological sample using a certain dye, only the objective tissues can be analyzed. Also, a fluorescence microscope can be used.

### BACKGROUND OF THE INVENTION AND RELATED ART STATEMENT

The present invention relates to an imaging mass spectrometer wherein a sample is moved and stopped repeatedly, and while the sample is stopped, a laser beam is irradiated to ionize the sample; and individual sections of the sample are analyzed and images of the sample analyzed are generated. Specifically, the invention relates to an imaging mass spectrometer equipped with an ion source by means of laser desorption ionization (LDI) or matrix-assisted laser desorption ionization (MALDI). One of the typical applications of such an apparatuses is a microscope mass spectrometer or a mass microscope.

Using LDI, samples are ionized by irradiating a laser beam thereon to enhance the movements of electric charges in the substances that adsorbs the laser beam. In MALDI, in order to analyze the samples not readily laser beam absorbent, or samples susceptible to laser damage such as proteins, such samples are laser irradiated and ionized after being mixed with a matrix made of a laser beam absorbent material.

MALDI mass spectrometry apparatuses, in particular, are capable of analyzing high molecular compounds with minimum degradation of such compounds and well suited for trace analysis, and thus, in recent years, have been widely utilized in the life science and other fields. A mass spectrometry apparatus comprising an LDI or MALDI ion source is referred to generally as an LDI/MALDI-MS herein.

Employing an LDI/MALDI-MS while reducing the laser beam spot diameter and moving the laser irradiated positions on a sample (typically, the sample is moved into position) produces an image showing the distribution of mass analysis measurements. This is referred to as an imaging mass spectrometry apparatus. It is often used as a microscope (mass spectrometry microscope) by focusing the laser beam with spot diameter from several hundreds to several microns (μm) (non-patent reference 1 and patent reference 1).

FIG. 1 shows one example of a conventional mass spectrometry microscope construction. An operator observes the sample 12 through a CCD or an ocular lens in the viewing system 11 and determines the region to be analyzed based on the image observed. When the operator performs the start operation, the irradiating system 13 irradiates a laser beam onto the sample 12 while the stage actuator 14 effects the two-dimensional movements of the sample stage 16 on which the sample 12 is placed.

The sample 12 is ionized in the locations where the laser beam is directed, and ions 17 generated enter the mass analyzer 18. The ions are separated according to the mass numbers (mass-to-charge ratio) and detected by the detector 19.

The signals from the detector 19 are sent to the measuring and control system 20 (a PC with dedicated software installed therein is often used). At the measuring and control system 20, the mass analysis data is correlated with the locations on the sample 12 (i.e., the positions on the sample 12 where the laser beam is irradiated) to generate an image. The image generated is displayed and/or printed out.

Patent reference 1: U.S. Pat. No. 5,808,300

Non-patent reference 1: Yasuhide Naito, “Mass Spectrometry Microscope Suited for Biological Samples,” Journal of Mass Spectrometry Society of Japan, Vol. 53, No. 3, 2005, pp. 125-132.

One of the major objectives of an imaging mass spectrometry or microscope mass spectrometry is analysis of the composition of biological tissues and cells. The need to analyze proteins and saccharides in biological samples is particularly considerable. Certain proteins and saccharides, however, are sparsely present in a biological sample, which makes it difficult for mass spectrometry to obtain a sufficient level of target signal intensity for reliable results.

It is therefore an object of the present invention to solve these problems and provide an imaging mass spectrometry apparatus capable of performing a highly reliable analysis of even a sparsely present component.

Further objects and advantages of the invention are apparent from the following description of the invention.

### SUMMARY OF THE INVENTION

The imaging mass spectrometry apparatus or imaging mass spectrometer according to the present invention devised to solve the aforementioned problems comprises a sample image generator for generating an image of a sample, a region selector for selecting a predetermined region from the sample image, a laser irradiator for irradiating a spot-shaped laser beam against the sample, a scanning portion for changing the position of the sample relative to the laser beam spot within the selected region, and amass analyzer for analyzing the ions generated from the laser irradiated locations of the sample.

In the imaging MS apparatus according to the present invention, mass analysis is performed with scanning, with a laser beam spot, on a predetermined region, which is selected beforehand based on the image extracted information of the sample generated. The analysis of the target region, therefore, can be accomplished in a short period of time. In many samples, a region is defined by the color or the brightness, which contains substantially the same or similar components, so the analysis can be expedited. Moreover, by computing the sum (or the average) of the results in the region, the analysis of the components present in the region can be effected at a high level of sensitivity (S/N ratio). By computing complex statistical values, such as variances, more in-depth information related to the presence of the components in the sample can be obtained.

For example, performing a staining process on a biological sample using a certain dye or the like enables the coloring of specific tissues. The use of this apparatus of the present invention, therefore, enables the analysis of the components that are present in the tissue quickly and with a high level of accuracy.

### BRIEF DESCRIPTION OF THE DRAWINGS

FIG. 1 is a schematic diagram showing a construction of a microscope mass spectrometer conventionally used, and also used in the present invention.

FIG. 2 is a block diagram showing the functions of the measuring and control system in the microscope mass spectrometer of the invention.

FIG. 3 is a flow chart showing the operation of the measuring and control system in the microscope mass spectrometer in the example.

FIG. 4(a) shows a CCD image of a sample, and FIG. 4(b) shows an image of a selected region.

FIG. 5 is an explanatory diagram showing the scanning condition of the selected region.

FIG. 6 is a graph showing the relationship between the overall brightness and individual colors red, green and blue in the sample image.

### DETAILED DESCRIPTION OF THE EMBODIMENTS

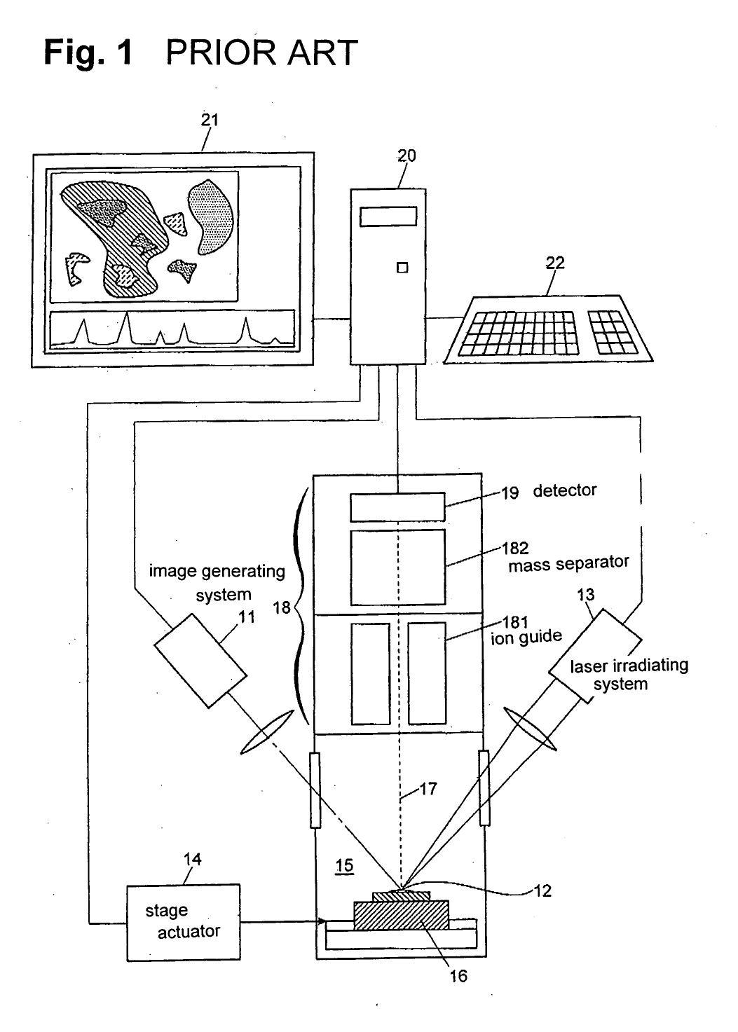

A microscope mass spectrometer, which is one example of the present invention, will be explained below. The hardware composition of the microscope mass spectrometry apparatus is essentially the same as the aforementioned conventional microscope. In other words, the main body, as shown in FIG. 1, comprises a sample chamber 15 and a mass analyzer 18, an image generating system 11 for viewing and generating the image of a sample through a window provided therein, and a laser irradiating system 13 for irradiating a laser beam, which is narrowed to form a fine spot, on the sample 12 through a laser irradiation window. The main body is connected to a personal computer with dedicated software programs installed thereon for the control and measurements performed by the microscope mass spectrometer, as well as for data processing, which constitute the measuring and control system 20.

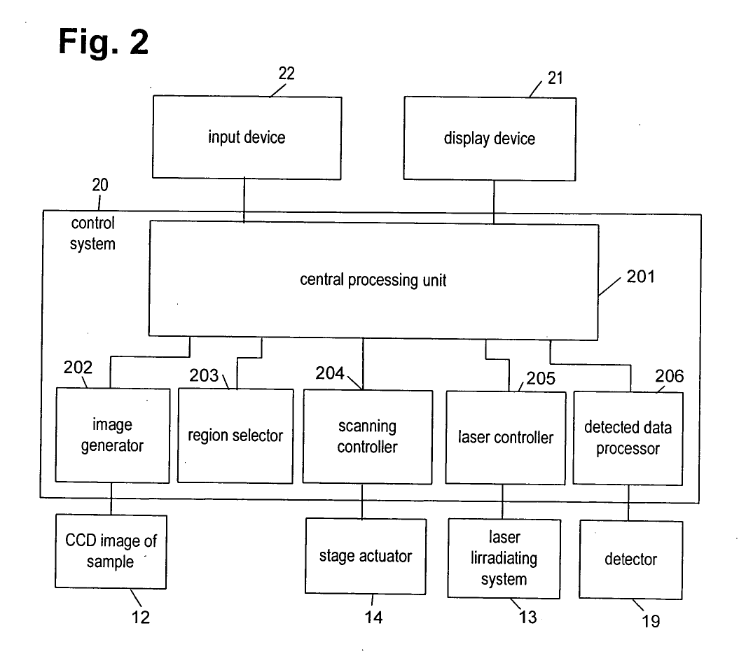

In executing the aforementioned dedicated programs, the measuring and control system 20 operates as a system having the functional blocks shown in FIG. 2.

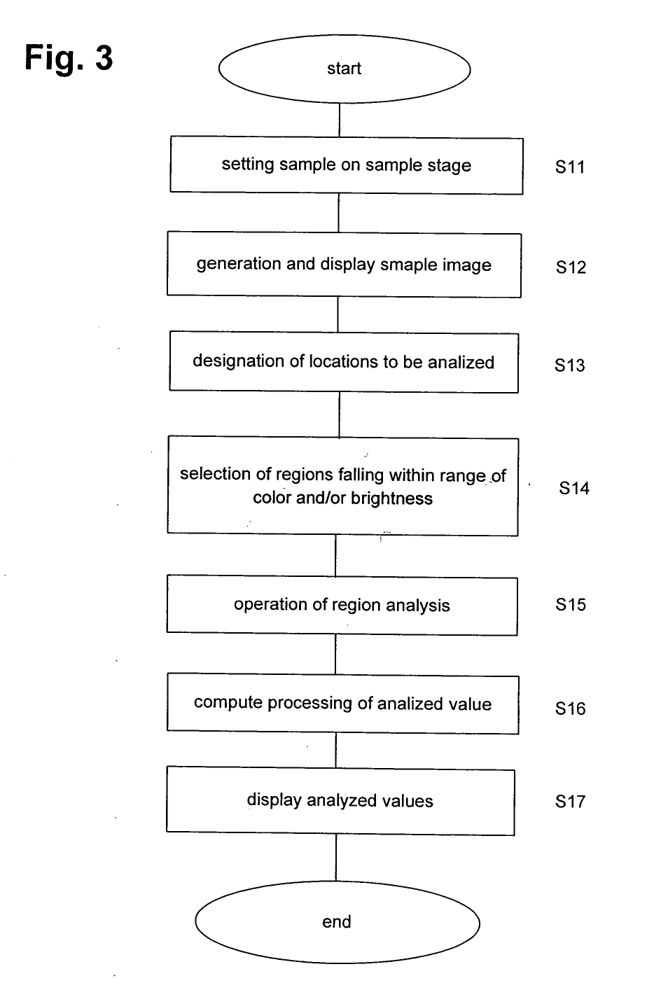

The operation of the microscope mass spectrometer constructed as described in the above example will be explained with reference to the flow chart shown in FIG. 3. A sample 12 is set on the sample stage 16 within the sample chamber (Step S11). At this time, the sample chamber 15 wherein the sample stage 16 is located is completely sealed from the mass analyzer 18 so as not to reduce the degree of vacuum in the mass analyzer 18. After the sample 12 is set, the door to the sample chamber 15 is tightly sealed and air in the sample chamber 15 is exhausted until the degree of vacuum reaches a predetermined level. Then, the small opening located between the sample chamber 15 and the mass analyzer 18 is opened to allow ions to pass through. Ionization may be performed without creating a vacuum in the sample chamber 15, and thus performed at atmospheric pressure, on occasion.

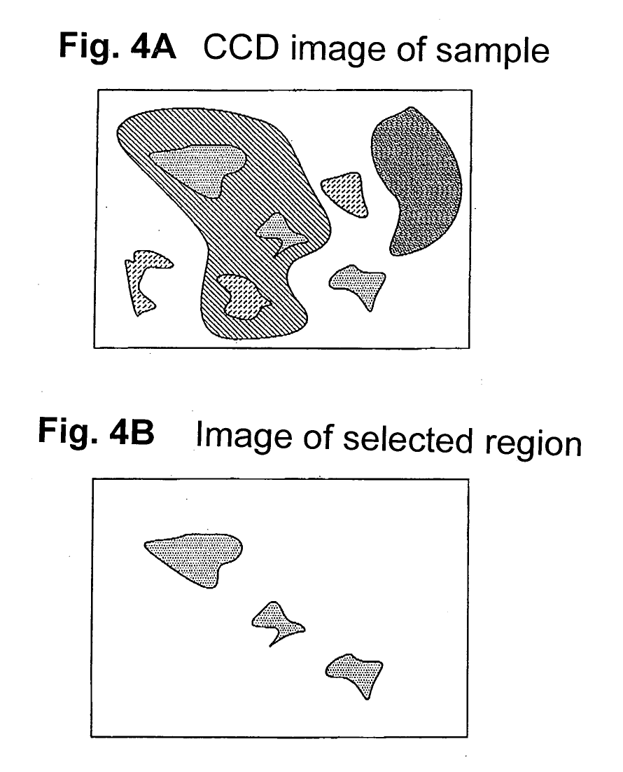

In the image generating system 11, the image of the sample 12 is generated by a CCD color camera via a window. The image data is sent from the CCD camera to the image generator 202 of the measuring and control system 20. The measuring and control system 20 displays the sample image at a predetermined region (window) on the display device (S12). FIG. 4(a) shows an example of such an image.

In analyzing a biological sample using this microscope mass spectrometer, for example, a user often is able to roughly identify, by the color, tissues based on the user's empirical knowledge when viewing the color image. The user, while viewing the color image on the screen, designates the locations to be analyzed using an input device 22, such as a mouse (S13). The region selector 203 then selects the regions falling within the range of colors designated by the user (S14, FIG. 4(b)). A region maybe selected by setting a range of colors or, as shown in FIG. 6, a range of brightness levels based on the brightness data prepared using color specific data (or data for specific colors). When a fluorescence microscope is used as an image generating system 11, the range is set by using only brightness values. In either way, it is desirable to have the region selector 203 arranged so as to allow the user to freely set the range of colors or brightness to be used when selecting the region of interest. By setting a desired range, the user can determine which of the selected regions whose sizes vary in accordance with the set range would be appropriate for analysis.

The region selector 203 may also be arranged so as to allow the user to set multiple ranges of colors or luminous intensity values, such as concurrently selecting both red and violet regions, or two brightness levels ranging 0 (black)-0.2 and 0.8-1 (white), for example.

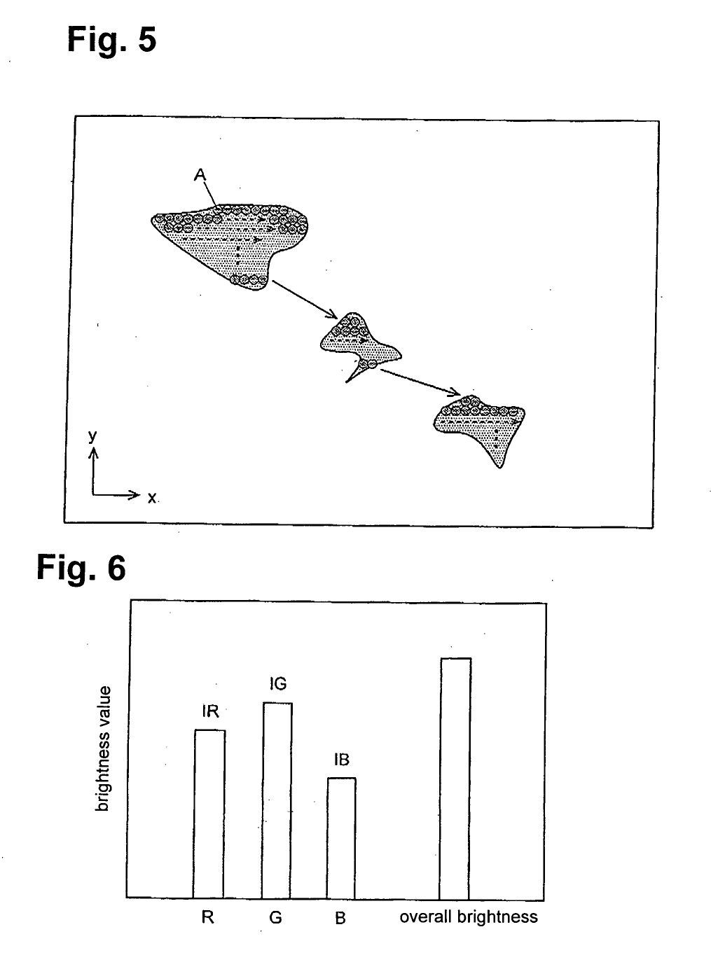

After determining that the selected region is appropriate, the user operates the input device 22 to effect the command to begin the analysis. The scanning controller 204 transmits a control signal to the stage actuator 14 to move the sample stage 16 to position an edge (dot A in FIG. 5) of the selected region to the laser beam irradiation location. When the dot A reaches that location, the scanning controller 204 sends a command to the stage actuator 14 to allow for the scanning of the region with a laser beam spot. In response to the command, the stage actuator 14 operates the sample stage 16 to repeat the following: move the sample stage in the direction X by a short predetermined distance Δx and pause for a short predetermined duration at each location (FIG. 5). The laser controller 205 transmits a command signal to the laser irradiating system 13 to emit a laser beam to that location while the sample 12 is at a stop. This generates ions from the sample, and the ions generated are drawn into the mass separator 182 due to the pressure difference between the sample chamber 15 and the mass analyzer 18 as well as the electrical field created by the ion guide 181. The ions are separated in accordance with the mass numbers (mass-to-charge ratio) in the mass separator 182. The separated ions are detected by the detector 19.

When the location irradiated by the laser beam reaches the other edge of the selected region, the stage actuator 14 moves the sample in the direction Y by a predetermined distance to perform the scanning of the next row. If the region consists of multiple islands, the sample is moved between the spaces between the islands at high speed.

During the scanning process, the detector 19 of the mass analyzer 18 transmits the signals based on the ions separated and detected for each mass number at each location to the detected data processor 206 of the measuring and control system 20. The detected data processor 206 computes the intensity per mass number based on the signals transmitted from the detector 19, and transmits the data (detected data) to the central processing unit 201. Based on the control signals transmitted from the scanning controller 204 (or the stage position signals transmitted from the stage actuator 14), the central processing unit 201 correlates the information for each measured location of the sample 12 with the detected data to be stored in a predetermined memory region (S15).

When the entire region selected is scanned, the central processing unit 201 computes the sum or the average, as well as statistical values, such as variances and standard deviations as needed, based on the detected data for the entire region (S17). When the sum or the average statistical value is obtained in this manner, the value represents the sum or the average of the analyzed values of the region of the same color of the sample. Accordingly, in a biological sample where there is strong correlation between colors and tissue composition, for example, a high sensitivity (high S/N ratio) mass spectrum of a tissue section represented by a particular color can be obtained.

When a staining process is applied to a biological sample, the colored section can be selectively analyzed, which enables high sensitivity analysis of the biological composition of the stained region. Since biological samples can be colored with tissue specific dyes, this technique can provide a useful effect in analyzing biological samples.

By installing an excitation light source, such as an ultraviolet light, in the image generating system 11 so as to generate the fluorescent image of a sample, even more information about the biological sample can be obtained.

Instead of computing the statistical values from the aggregated detected data for the entire region (all measured locations) as described above, the detected data for each location may be superimposed on the sample image 4(a) (or the image of a selected region 4(b)). In this case, if a color is set beforehand, instead of designating a representative location to be analyzed, in the step S13 described above, the region selector 203 automatically selects and extracts a colored or fluorescing section. This eliminates the need for the user to individually match the colored or fluorescing section to the laser ionized region, and thus provides the benefit of simplifying the mass analysis of the colored or fluorescing section.

The disclosure of Japanese Patent Application No. 2005-319495 filed on Nov. 2, 2005 is incorporated as a reference.

While the invention has been explained with reference to the specific embodiments of the invention, the explanation is illustrative and the invention is limited only by the appended claims.

What is claimed is:

1. An imaging mass spectrometer, comprising:
a sample image generator for generating an image of a sample,
a region selector for selecting a predetermined region with a specific characteristic from the sample image,
a laser irradiator for irradiating a spot-shaped laser beam against the sample,
a scanning portion for changing a position of the sample relative to the laser beam spot within the selected region, and
a mass analyzer for analyzing ions generated by laser at a location of the sample.

2. An imaging mass spectrometer according to claim 1, wherein said region selector selects a section of the image falling within a predetermined range of colors.

3. An imaging mass spectrometer according to claim 1, wherein said region selector selects a section of the image falling within a predetermined range of brightness.

4. An imaging mass spectrometer according to claim 2, wherein said range of colors is variable.

5. An imaging mass spectrometer according to claim 3, wherein said range of brightness is variable.

6. An imaging mass spectrometer according to claim 1, wherein said region selector selects a plurality of sections within the image.

7. An imaging mass spectrometer according to claim 1, wherein said sample image generator is a fluorescence microscope.

8. An imaging mass spectrometer according to claim 1, further comprising an arithmetic unit to compute statistical values from mass spectrometric values of individual points in a selected region.

9. An imaging mass spectrometric method comprising the steps of:
generating an image of a sample,
selecting a region in the image in accordance with predetermined criteria, and
performing a mass analysis of the region while scanning the sample in the selected region with a laser beam spot.

10. An imaging mass spectrometric method according to claim 9, wherein the sample is subjected to a staining process beforehand, and the region is selected based on color.

11. An imaging mass spectrometric method according to claim 10, wherein the sample is subjected to a fluorescent staining process beforehand, and the region is selected based on fluorescent color.
